(19) United States
(12) Patent Application Publication
(10) Pub. No.: US 2009/0249802 A1
(43) Pub. Date: Oct. 8, 2009

(54) Vehicle HVAC and Battery Thermal Management

(75) Inventors: Mark D. Nemesh, Troy, MI (US); Edwin J. Stanke, Pontiac, MI (US); Matthew J. Martinchick, Farmington, MI (US); Wissam Ibri, Sterling Heights, MI (US); Kulwinder Singh, Lake Orion, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/062,760

(22) Filed: Apr. 4, 2008

(51) Int. Cl. F25D 23/12; B60H 1/32

(52) U.S. Cl. 62/56; 62/259.2; 62/498; 62/214

(57) ABSTRACT

An HVAC system for a vehicle having a battery pack, and a method of operation, is disclosed. The HVAC system may comprise a refrigerant loop having a first leg and a second leg, and a refrigerant compressor in the refrigerant loop. In the first leg, an evaporator provides cooling to a passenger cabin of the vehicle, an evaporator shut-off valve selectively blocks the flow of refrigerant through the evaporator, and an evaporator thermal expansion valve is upstream from the evaporator. In the second leg, a battery heat exchanger receives the refrigerant, a battery thermal expansion valve is located upstream from the battery heat exchanger, and a battery cooling shut-off valve selectively blocks the flow of refrigerant through the battery heat exchanger. The shut-off valves and compressor are controlled to control the cooling of the passenger cabin and the battery pack.

### BACKGROUND OF INVENTION

The present invention relates generally to heating, ventilation and air conditioning (HVAC) systems and thermal systems for battery packs in vehicles.

Advanced automotive vehicles are being introduced that employ a battery pack to store large amounts of energy for electric propulsion systems. These vehicles may include, for example, plug-in hybrid electric vehicles, electric vehicles with an internal combustion engine that is used as a generator for battery charging, and fuel cell vehicles. In general, these battery packs require some type of thermal system for cooling and warming the battery pack.

Typical battery thermal systems used to cool and warm the battery pack rely on air flow from the vehicle HVAC system. This may be passenger cabin air that is directed through the battery pack. But these systems suffer from drawbacks such as low heat rejection due to the low heat transfer coefficient of air, interior passenger cabin noise, vibration and harshness (NVH) due to battery blower motor and air rush noise, limited battery cooling capacity after the vehicle has been parked in the sun (due to high air temperatures in the passenger cabin at the beginning of the drive cycle), and difficulty in ensuring that an air inlet grille between the passenger cabin and the battery thermal system does not get accidentally blocked by vehicle passengers (resulting in reduced or no battery air cooling flow).

### SUMMARY OF INVENTION

An embodiment contemplates a HVAC system for a vehicle having a battery pack. The HVAC system may comprise a refrigerant loop having a first leg and a second leg, and a refrigerant compressor in the refrigerant loop. In the first leg, an evaporator provides cooling to a passenger cabin of the vehicle, an evaporator shut-off valve selectively blocks the flow of refrigerant through the evaporator, and an evaporator thermal expansion valve is upstream from the evaporator. In the second leg, a battery heat exchanger receives the refrigerant, a battery thermal expansion valve is located upstream from the battery heat exchanger, and a battery cooling shut-off valve selectively blocks the flow of refrigerant through the battery heat exchanger.

An embodiment contemplates a method of cooling a passenger cabin and a battery pack of a vehicle, the method comprising the steps of: detecting a level of cooling requested for the passenger cabin; detecting a level of cooling required for the battery pack; if passenger cabin cooling is requested and a relatively equally high level of battery pack cooling are detected, then a refrigerant compressor is activated, an evaporator shut-off valve is opened to allow a refrigerant to flow through an evaporator and a battery cooling shut-off valve is opened to allow the refrigerant to flow through a battery heat exchanger; if no passenger cabin cooling and no battery pack cooling are detected, then the refrigerant compressor is not operated; if a higher level of requested passenger cabin cooling is detected versus a relatively lower level of required battery pack cooling, then the refrigerant compressor is activated, the evaporator shut-off valve is opened to allow the refrigerant to flow through the evaporator and the battery cooling shut-off valve is cycled between allowing and blocking the refrigerant from flowing through the battery heat exchanger; and if a higher level of required battery pack cooling is detected versus a relatively lower level of requested passenger cabin cooling, then the refrigerant compressor is activated, the battery cooling shut-off valve is opened to allow the refrigerant to flow through the battery heat exchanger and the evaporator shut-off valve is cycled between allowing a blocking the refrigerant from flowing through the evaporator.

An embodiment contemplates a method of cooling a passenger cabin and a battery pack of a vehicle, the method comprising the steps of: detecting a level of cooling requested for the passenger cabin; detecting a level of cooling required for the battery pack; if no passenger cabin cooling is requested and battery pack cooling is required, then a refrigerant compressor is cycled on and off, an evaporator shut-off valve is closed to prevent a refrigerant flow through an evaporator and a battery cooling shut-off valve is opened to allow the refrigerant to flow through a battery heat exchanger; and if no required battery pack cooling is required and passenger cabin cooling is requested, then the refrigerant compressor is cycled on and off, the battery cooling shut-off valve is closed to prevent the refrigerant flow through the battery heat exchanger and the evaporator shut-off valve is opened to allow the refrigerant to flow through the evaporator.

An advantage of an embodiment is that the vehicle HVAC system will meet varying passenger cabin air conditioning loads while also being able to meet varying battery cooling loads. The use of refrigerant shut-offs in the refrigerant loop just upstream of the evaporator and a battery heat exchanger allows for added HVAC operating states to meet the varying passenger cabin and battery cooling loads. The shut-off valves can be cycled open and closed and the compressor speed (RPM) can be varied to maximize the ability to account for the varying cooling loads. Moreover, by maintaining the desired temperature within the battery pack, this may allow one to maximize the battery life.

### BRIEF DESCRIPTION OF DRAWINGS

FIG. 1 is a schematic illustration of a vehicle having a HVAC system according to a first embodiment.

FIG. 2 is a schematic illustration of a vehicle having a HVAC system according to a second embodiment.

FIG. 3 is a schematic illustration of a vehicle having a HVAC system according to a third embodiment.

FIG. 4 is a table showing operating states used in a method for meeting various cooling needs of the passenger cabin and battery pack.

### DETAILED DESCRIPTION

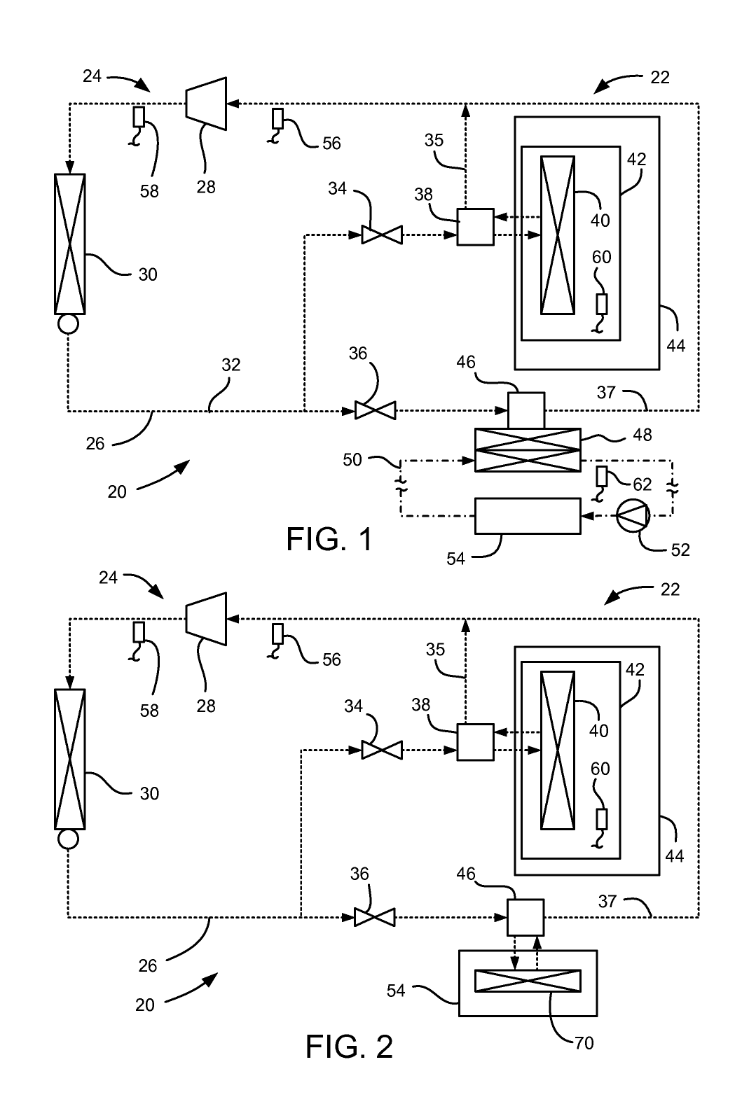

Referring to FIG. 1, a portion of a vehicle, indicated generally at 20, includes a vehicle HVAC system 22. The HVAC system 22 includes an air conditioning portion 24 having a refrigerant loop 26. The refrigerant loop 26 includes a refrigerant compressor 28 in fluid communication with a condenser 30. The refrigerant compressor 28 may be electrically driven, with an ability to adjust the speed (RPMs) of the compressor during operation. The condenser 30, in turn, directs refrigerant into a refrigerant line 32 that forks into two legs 35, 37 of the refrigerant loop 26 to direct refrigerant into both an evaporator shut-off valve 34 and a battery cooling shut-off valve 36. The evaporator shut-off valve 34 selectively allows for and restricts the flow of refrigerant through it into an evaporator thermal expansion valve 38. The evaporator thermal expansion valve 38, in turn, is in fluid communication with an evaporator 40, which is located in a heating, ventilation and air conditioning (HVAC) module 42 in a passenger cabin 44 of the vehicle 20. Refrigerant exiting the evaporator 40 is directed through a return portion of the evaporator thermal expansion valve 38 and back to the compressor 28 to complete one leg 35 of the refrigerant loop 26.

The battery cooling shut-off valve 36 selectively allows for and restricts the flow of refrigerant through it into a battery thermal expansion valve 46. The battery thermal expansion valve 46 is, in turn, in fluid communication with a battery refrigerant-to-coolant heat exchanger 48. Refrigerant exiting the heat exchanger 48 is directed through a return portion of the battery thermal expansion valve 46 and back to the compressor 28 to complete the second leg 37 of the refrigerant loop 26.

The heat exchanger 48 is also in fluid communication with a coolant loop 50. The dashed lines in FIGS. 1-3 represent conduits through which refrigerant flows, while the dash-dot lines represent conduits through which a coolant liquid flows. The coolant may be a conventional liquid mixture such as an ethylene glycol and water mix, or may be some other type of liquid with suitable heat transfer characteristics. The coolant loop 50 may also include a coolant pump 52 for pumping the coolant through the loop 50. The coolant loop 50 flows through a battery pack 54, where the coolant is employed to cool the battery pack 54.

The HVAC system 22 may also include various sensors for detecting a temperature or pressure at certain points in the system. For example, the HVAC system 22 may include a low side pressure sensor 56 for measuring refrigerant pressure just prior to the refrigerant entering the compressor 28 and a high side pressure sensor 58 for measuring the refrigerant pressure just after the refrigerant exits the compressor 28. An evaporator air temperature sensor 60 may be employed to measure the temperature of air flowing out of the evaporator 40. Also, a coolant temperature sensor 62 may be employed to measure the temperature of coolant exiting the heat exchanger 48.

FIG. 2 illustrates a second embodiment. Since this embodiment is similar to the first, similar element numbers will be used for similar elements, and the detailed description thereof will be omitted. In this embodiment, there is no coolant loop and the refrigerant loop 26 of the HVAC system 22 is only somewhat modified from the first embodiment. The battery thermal expansion valve 46 directs the refrigerant to a battery heat exchanger 70 in the battery pack 54. Thus, rather than a coolant flowing through the battery pack 54, the refrigerant flows through the battery pack 54. The evaporator shut-off valve 34 and battery cooling shut-off valve 36 still selectively restrict the flow of refrigerant through the two legs 35, 37 of the refrigerant loop 26.

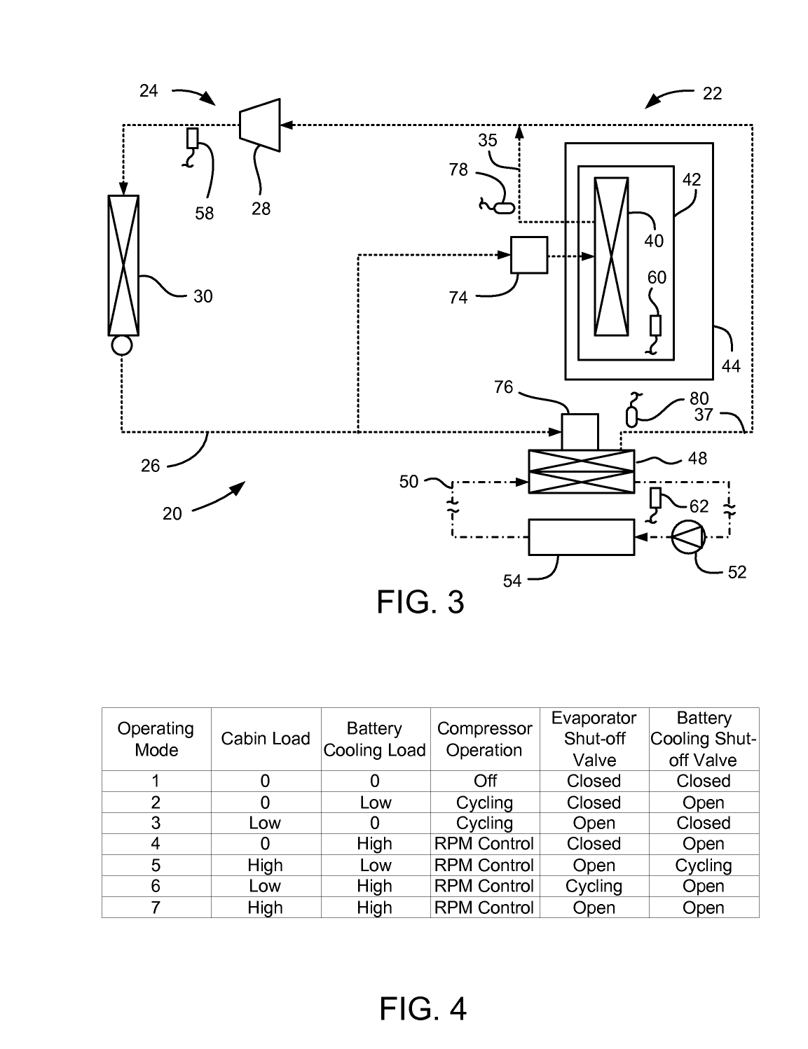

FIG. 3 illustrates a third embodiment. Since this embodiment is similar to the first, similar element numbers will be used for similar elements, and the detailed description thereof will be omitted. In this embodiment, the evaporator shut-off valve and evaporator thermal expansion valve of the first embodiment are replaced with an evaporator electronic thermal expansion valve 74, and the battery cooling shut-off valve and the battery thermal expansion valve of the first embodiment are replaced with a battery electronic thermal expansion valve 76. The two electronic thermal expansion valves 74, 76 now selectively restrict the flow of the refrigerant through the two legs of the refrigerant loop 26. Due to the operating characteristics of the electronic thermal expansion valves 74, 76, a first pressure and temperature sensor 78 measures the refrigerant after it exits the evaporator 40, while a second pressure and temperature sensor 80 measures the refrigerant after it exits the heat exchanger 48. The coolant loop 50 may remain essentially the same as in the first embodiment.

Alternatively, the electronic thermal expansion valves of the embodiment of FIG. 3 may be employed in the embodiment shown in FIG. 2 by replacing the shut-off valves and thermal expansion valves of FIG. 2 with the electronic thermal expansion valves as shown in FIG. 3.

FIG. 4 illustrates a table showing operating states used in a method for meeting various cooling needs of the passenger cabin 44 and battery pack 54 illustrated in FIG. 1. While the operating method of FIG. 4 will be discussed relative to FIG. 1, essentially the same operating method can be employed with the embodiments of FIGS. 2 and 3.

The need for battery cooling may be dependent upon current electric power usage as well as the current battery temperature, which can be different than the current passenger cabin cooling load. The use of the evaporator shut-off valve 34 in the refrigerant loop 26 just upstream of the evaporator 40 and the battery cooling shut-off valve 36 just upstream of the heat exchanger 48 allows for added HVAC operating states. The shut-off valve on the component demanding the lower cooling load can be closed or cycled open and closed to account for the difference in cooling loads.

For operating mode 1, the passenger cabin air conditioning is off and battery cooling is not currently needed (indicated by zeros in the table of FIG. 4). In this operating mode, then, the compressor 28 is off, so no refrigerant will flow. The valves 34, 36 may also be closed.

For operating mode 2, the passenger cabin air conditioning is off (so refrigerant flow through the evaporator 40 is not needed) and the vehicle 20 may be in electric operating mode, with a low battery cooling load. The evaporator shut-off valve 34 is closed, and the battery cooling shut-off valve 36 is opened. The compressor 28 is cycled on and off based only on the current battery cooling needs. The low side pressure sensor 56 and the coolant temperature sensor 62 may be employed to provide data needed to determine the timing of the compressor cycling. The compressor 28 may also be run at less than maximum RPMs to accommodate the limited battery cooling needed, if so desired.

For operating mode 3, the passenger cabin may be in a dehumidification mode (thus having a low cabin cooling load), with no battery cooling currently needed. The evaporator shut-off valve 34 is opened and the battery cooling shut-off valve 36 is closed. The compressor 28 is cycled on and off using the evaporator air temperature sensor 60 and the low side pressure sensor 56 as two of the for inputs in determining the timing of the cycling. The compressor 28 may also be run at less than maximum RPMs to accommodate the limited passenger cabin cooling needed, if so desired.

For operating mode 4, the passenger cabin air conditioning is off, and the vehicle 20 may be operating in electric vehicle mode with a high battery cooling need (such as electric vehicle mode operation while driving up long steep grade roads). The evaporator shut-off valve 34 is closed, and the battery cooling shut-off valve 36 is opened. The compressor 28 is on with adjustments to the speed of the compressor (RPM control) used to precisely meet the battery cooling needs. In this operating mode, a minimum suction side refrigerant pressure can be adjusted lower than under typical cabin evaporator conditions, thus in effect increasing the effectiveness of the battery refrigerant-to-coolant heat exchanger 48, if so desired. This can occur because a need to avoid ice formation on the evaporator 40 is not a concern in this operating mode.

For operating mode 5, the passenger cabin air conditioning is on high, while the battery pack 54 only needs a small amount of cooling. This may occur, for example, during initial cool down of a heat soaked passenger cabin 44 while only mild electrical loads are placed on the battery pack 54. The evaporator shut-off valve 34 is opened and the compressor 28 is operating (although RPM control may be employed if needed), while the battery cooling shut-off valve 36 is cycled open and closed to account for the lower cooling load needed for the battery pack 54. The coolant temperature sensor 62 may be used as an input to determine when the valve cycling needs to occur.

For operating mode 6, the passenger cabin air conditioning is on low, and the vehicle 20 may be operating in electric vehicle mode with a high battery cooling need (such as electric vehicle mode operation while driving up long steep grade roads). The battery cooling shut-off valve 36 is opened and the compressor 28 is operating (although RPM control may be employed if needed), while the evaporator shut-off valve 34 is cycled open and closed to account for the lower cooling load needed for the passenger cabin 44. The evaporator air temperature sensor 60 may be used as an input to determine when the cycling needs to occur.

For operating mode 7, both the passenger cabin and battery cooling loads are high. This may occur, for example, during initial cool down of a heat soaked passenger compartment while the vehicle 20 may be operating in electric vehicle mode with a high battery cooling need (such as electric vehicle mode operation while driving up long steep grade roads). Both shut-off valves 34, 36 are opened and the compressor 28 is operating to provide maximum cooling to both the passenger cabin 44 and the battery pack 54.

While certain embodiments of the present invention have been described in detail, those familiar with the art to which this invention relates will recognize various alternative designs and embodiments for practicing the invention as defined by the following claims.

What is claimed is:

1. A HVAC system for a vehicle having a battery pack, the HVAC system comprising:
a refrigerant loop having a first leg and a second leg;
a refrigerant compressor in the refrigerant loop;
an evaporator in the first leg and configured to provide cooling to a passenger cabin of the vehicle;
an evaporator shut-off valve in the first leg configured to selectively block the flow of refrigerant through the evaporator;
an evaporator thermal expansion valve in the first leg upstream from the evaporator;
a battery heat exchanger in the second leg;
a battery thermal expansion valve in the second leg upstream from the battery heat exchanger; and
a battery cooling shut-off valve in the second leg configured to selectively block the flow of refrigerant through the battery heat exchanger.

2. The HVAC system of claim 1 wherein the battery heat exchanger is located in the battery pack.

3. The HVAC system of claim 1 wherein the battery heat exchanger is a refrigerant-to-coolant heat exchanger, and the HVAC system includes a coolant loop providing coolant flowing through the refrigerant-to-coolant heat exchanger, the coolant loop directing the coolant flow through the battery pack.

4. The HVAC system of claim 2 including a coolant temperature sensor located adjacent to and downstream from the refrigerant-to-coolant heat exchanger, the coolant temperature sensor configured to measure a temperature of the coolant flowing from the refrigerant-to-coolant heat exchanger.

5. The HVAC system of claim 1 including a low side pressure sensor configured to measure a refrigerant pressure just upstream from the refrigerant compressor in the refrigerant loop, and a high side pressure sensor configured to measure the refrigerant pressure just downstream from the refrigerant compressor in the refrigerant loop.

6. The HVAC system of claim 1 wherein an evaporator electronic thermal expansion valve includes the evaporator shut-off valve and the evaporator thermal expansion valve.

7. The HVAC system of claim 6 wherein a battery electronic thermal expansion valve includes the battery cooling shut-off valve and the battery thermal expansion valve.

8. The HVAC system of claim 7 including a first pressure and temperature sensor located in the first leg downstream from the evaporator and a second pressure and temperature sensor located in the second leg downstream from the battery heat exchanger.

9. The HVAC system of claim 1 wherein a battery electronic thermal expansion valve includes the battery cooling shut-off valve and the battery thermal expansion valve.

10. A method of cooling a passenger cabin and a battery pack of a vehicle, the method comprising the steps of:
(a) detecting a level of cooling requested for the passenger cabin;
(b) detecting a level of cooling required for the battery pack;
(c) if passenger cabin cooling is requested and a relatively equally high level of battery pack cooling is detected, then a refrigerant compressor is activated, an evaporator shut-off valve is opened to allow a refrigerant to flow through an evaporator and a battery cooling shut-off valve is opened to allow the refrigerant to flow through a battery heat exchanger;
(d) if no passenger cabin cooling and no battery pack cooling are detected, then the refrigerant compressor is not operated;
(e) if a higher level of requested passenger cabin cooling is detected versus a relatively lower level of required battery pack cooling, then the refrigerant compressor is activated, the evaporator shut-off valve is opened to allow the refrigerant to flow through the evaporator and the battery cooling shut-off valve is cycled between allowing and blocking the refrigerant from flowing through the battery heat exchanger; and
(f) if a higher level of required battery pack cooling is detected versus a relatively lower level of requested passenger cabin cooling, then the refrigerant compressor is activated, the battery cooling shut-off valve is opened to allow the refrigerant to flow through the battery heat exchanger and the evaporator shut-off valve is cycled between allowing and blocking the refrigerant from flowing through the evaporator.

11. The method of claim 10 including (g) if no passenger cabin cooling is requested and battery pack cooling is required, then the refrigerant compressor is cycled on and off, the evaporator shut-off valve is closed to prevent the refrigerant flow through the evaporator and the battery cooling shut-off valve is opened to allow the refrigerant to flow through the battery heat exchanger.

12. The method of claim 10 including (g) if no required battery pack cooling is required and passenger cabin cooling is requested, then the refrigerant compressor is cycled on and off, the battery cooling shut-off valve is closed to prevent the refrigerant flow through the battery heat exchanger and the evaporator shut-off valve is opened to allow the refrigerant to flow through the evaporator.

13. The method of claim 10 including (g) if no passenger cabin cooling is requested and battery pack cooling is required, then a speed of the refrigerant compressor is controlled to meet the required battery pack cooling, the evaporator shut-off valve is closed to prevent the refrigerant flow through the evaporator and the battery cooling shut-off valve is opened to allow the refrigerant to flow through the battery heat exchanger.

14. The method of claim 10 wherein step (c) is further defined by a speed of the refrigerant compressor being controlled to meet the required battery pack cooling and the requested passenger cabin cooling.

15. The method of claim 10 including (g) if required battery pack cooling is detected, flowing a coolant through the battery heat exchanger and the battery pack.

16. A method of cooling a passenger cabin and a battery pack of a vehicle, the method comprising the steps of:
(a) detecting a level of cooling requested for the passenger cabin;
(b) detecting a level of cooling required for the battery pack;
(c) if no passenger cabin cooling is requested and battery pack cooling is required, then a refrigerant compressor is cycled on and off, an evaporator shut-off valve is closed to prevent a refrigerant flow through an evaporator and a battery cooling shut-off valve is opened to allow the refrigerant to flow through a battery heat exchanger; and
(d) if no required battery pack cooling is required and passenger cabin cooling is requested, then the refrigerant compressor is cycled on and off, the battery cooling shut-off valve is closed to prevent the refrigerant flow through the battery heat exchanger and the evaporator shut-off valve is opened to allow the refrigerant to flow through the evaporator.

17. The method of claim 16 including (e) if a higher level of requested passenger cabin cooling is detected versus a relatively lower level of required battery pack cooling, then the refrigerant compressor is activated, the evaporator shut-off valve is opened to allow the refrigerant to flow through the evaporator and the battery cooling shut-off valve is cycled between allowing and blocking the refrigerant from flowing through the battery heat exchanger.

18. The method of claim 16 including (e) if a higher level of required battery pack cooling is detected versus a relatively lower level of requested passenger cabin cooling, then the refrigerant compressor is activated, the battery cooling shut-off valve is opened to allow the refrigerant to flow through the battery heat exchanger and the evaporator shut-off valve is cycled between allowing and blocking the refrigerant from flowing through the evaporator.

19. The method of claim 16 including (e) if passenger cabin cooling is requested and a relatively equally high level of battery pack cooling are detected, then the refrigerant compressor is activated, the evaporator shut-off valve is opened to allow the refrigerant to flow through the evaporator and the battery cooling shut-off valve is opened to allow the refrigerant to flow through the battery heat exchanger.

20. The method of claim 16 including (e) if required battery pack cooling is detected, flowing a coolant through the battery heat exchanger and the battery pack.
